(19) United States
(12) Patent Application Publication
(10) Pub. No.: US 2005/0055604 A1
(43) Pub. Date: Mar. 10, 2005

(54) Batch processing wakeup/sleep mode switching control method and system

(76) Inventor: Chih-Wei Chen, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/655,167

(22) Filed: Sep. 4, 2003

(51) Int. Cl. G06F 11/00

(52) U.S. Cl. 714/13

(57) ABSTRACT

A batch processing wakeup/sleep mode switching control method and system is proposed, which is designed for use with an information platform for controlling the switching of a data processing module between wakeup mode and sleep mode during the processing of data packages in a batch-type manner to help reduce the rate of switching and thereby increase performance of data processing. The proposed wakeup/sleep mode switching control method and system is characterized by that the data processing unit is switched back to sleep mode only when no more data packages are received and stored in a temporary data storage module, rather than the conventional method of switching to sleep mode at the completion of the processing on each single data package. This batch-type switching control scheme can help reduce the rate of switching between wakeup mode and sleep mode and thereby increase the performance of data processing.

### BACKGROUND OF THE INVENTION

1. Field of the Invention

This invention relates to information technology, and more particularly, to a batch processing wakeup/sleep mode switching control method and system that is designed for use with an information platform, such as a Web server, for controlling the switching of a data processing module in the information platform between wakeup mode and sleep mode during the processing of a batch of data packages received from a data source.

2. Description of Related Art

Web servers are typically equipped with a high-capacity data storage unit, such as a RAID (Redundant Array of Independent Disks) unit, which is linked via a high-speed data transmission interface, such as Fibre Channel compliant interface, to provide large-volume data services to clients via the Internet.

During the operation of the Web server, when the Web server's data reception interface receives a data package from the data source, the server's operating system will promptly invoke a data processing unit (i.e., switch the data processing unit from sleep mode to wakeup mode) so as to use the data processing unit to perform a specific data processing function on the received data package, such as decoding, decompression, decryption, format conversion, and so on. By conventional switching control method, when the processing on the received data package is completed, the data processing unit is promptly switched back to sleep mode.

In the event that the data reception interface receives two or more data packages at the same time, the data processing unit will be switched from sleep mode to wakeup mode to process the firstly-received data package, and then promptly switched back to sleep mode at the completion of the processing on the firstly-received data package. Subsequently, since there are still unprocessed data packages, the data processing unit is then switched on again from sleep mode to wakeup mode to process the secondly-received data package, and then promptly switched back to sleep mode at the completion of the processing on the secondly-received data package. This procedure is repeated until all the received data packages have been processed.

One drawback to the foregoing wakeup/sleep mode switching control method, however, is that in the event of a large batch of data packages being received at the same time, the data processing unit will be repeatedly switched again and again between the wakeup mode and the sleep mode for each data package. This scheme will undoubtedly cause the server's operating system to spend much unnecessary time in the switching between wakeup mode and sleep mode, and therefore result in a low performance of data processing.

### SUMMARY OF THE INVENTION

It is therefore an objective of this invention to provide a batch processing wakeup/sleep mode switching control method and system, which can switch the data processing unit between wakeup mode and sleep mode in a batch manner to help reduce the rate of switching between wakeup mode and sleep mode and thereby increase the performance of data processing of a batch of data packages.

The batch processing wakeup/sleep mode switching control method and system according to the invention is intended for use with an information platform that is equipped with a data reception interface and a data processing unit wherein the data reception interface is used for receiving data packages from a data source while the data processing unit is used to process each received data package, and wherein the data processing unit is switchable between a wakeup mode and a sleep mode.

The batch processing wakeup/sleep mode switching control method and system according to the invention is capable of switching the data processing unit between the wakeup mode and the sleep mode in a batch-type manner for the purpose of reducing wakeup/sleep switching rate to help increase overall performance.

The batch processing wakeup/sleep mode switching control method and system according to the invention comprises the functions of storing each received data package into a temporary data storage module; then issuing a wakeup enable message to the data processing unit when the temporary data storage module is being changed from empty storage status to data package storage status, for the purpose of switching the data processing unit from sleep mode to wakeup mode; then retrieving the firstly-received data package from the temporary data storage module for processing by the data processing unit; and monitoring each data processing procedure performed by the data processing unit for each data package and generating a buffer-inspect message at the completion of the processing on each data package; and in response to the buffer-inspect message, inspecting whether the temporary data storage module is currently in empty storage status; if NO, retrieving the next data package from the temporary data storage module for processing by the data processing unit for processing; whereas if YES, issuing a sleep enable message to the data processing unit to switch the data processing unit to sleep mode. This switching control scheme can help reduce the rate of switching between wakeup mode and sleep mode and thereby increase the performance of data processing of a batch of data packages.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an object-oriented component model of the batch processing wakeup/sleep mode switching control system of the invention; and

FIG. 2 is a timing diagram used to show the processing of a batch of data packages by the invention and by the prior art.

### DETAILED DESCRIPTION OF PREFERRED EMBODIMENTS

The batch processing wakeup/sleep mode switching control method and system according to the invention is disclosed in full details by way of preferred embodiments in the following with reference to the accompanying drawings.

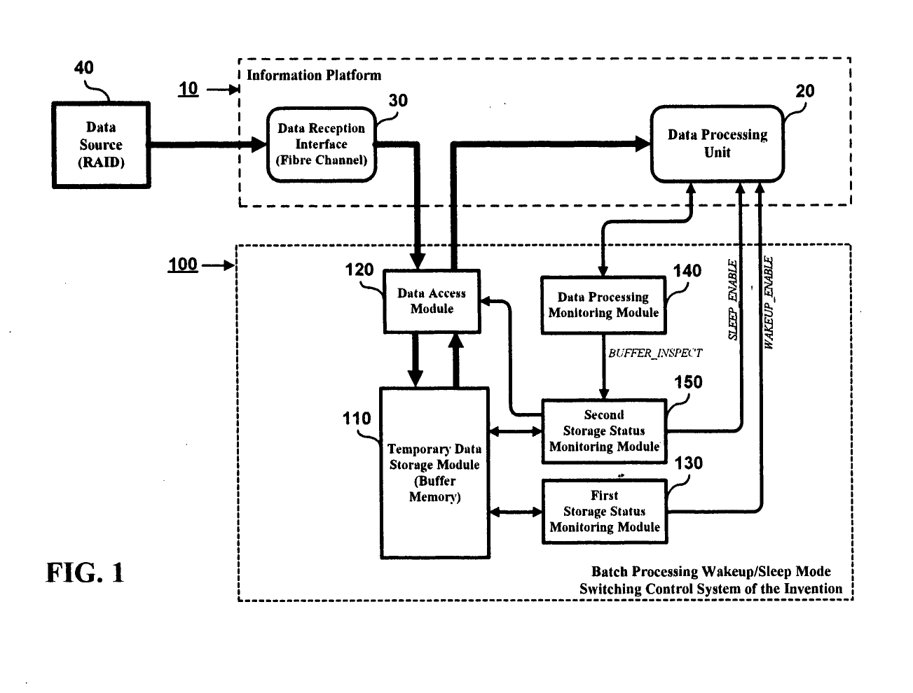

FIG. 1 is a schematic diagram showing the object-oriented component model of the batch processing wakeup/sleep mode switching control system according to the invention (as the part enclosed in the dotted box indicated by the reference numeral 100). As shown, the batch processing wakeup/sleep mode switching control system of the invention 100 is designed for use with an information platform 10, such as a Web server 10, that is equipped with a data processing unit 20 and a data reception interface 30.

The data reception interface 30 is, for example, a Fibre Channel compliant data reception interface, which is capable of receiving a series of data packages that are retrieved from a data source 40, such as a RAID (Redundant Array of Independent Disks) unit; and the data reception interface 30 is used to perform a specific data processing function on each received data package, such as decoding, decompression, decryption, format conversion, and so on. The data processing unit 20 has two operation modes: a wakeup mode and a sleep mode, wherein the wakeup mode allows the data processing unit 20 to actively perform its data processing function on a data package, and the sleep mode allows the data processing unit 20 to be deactivated to save system source of the Web server 10. At initialization, the data processing unit 20 is normally set to sleep mode.

The batch processing wakeup/sleep mode switching control system of the invention 100 is intended for use to switch the data processing unit 20 between the wakeup mode and the sleep mode in a batch-type manner for the purpose of reducing the rate of switching between the wakeup mode and the sleep mode to help increase the performance of data processing.

The batch processing wakeup/sleep mode switching control system of the invention 100 comprises: (a) a temporary data storage module 110; (b) a data access module 120; (c) a first storage status monitoring module 130; (d) a data processing monitoring module 140; and (e) a second storage status monitoring module 150.

The temporary data storage module 110 is, for example, a buffer memory, which is used to temporarily store each data package received by the data reception interface 30 from the data source 40. The storing and retrieving of data packages in and from this temporary data storage module 110 can be based on any kind of queuing scheme, such as a FIFO (First-In-First-Out) queuing scheme.

The data access module 120 is capable of performing an access operation on the temporary data storage module 110 to either store each received data package into the temporary data storage module 110 or retrieve one data package from the temporary data storage module 110 based on the queuing scheme of the temporary data storage module 110, such as FIFO queuing scheme.

The first storage status monitoring module 130 is capable of monitoring the current storage status of the temporary data storage module 110 and generating a wakeup enable message WAKEUP_ENABLE in the event of the temporary data storage module 110 being changed from empty storage status (i.e., the status wherein no data package is stored therein) to data package storage status (i.e., the status wherein at least one data package is stored therein), i.e., at the time a data package is being stored into the temporary data storage module 110 and the temporary data storage module 110 was previously empty without any data package stored therein. The wakeup enable message WAKEUP_ENABLE is transferred to the data processing unit 20 to activate the data processing unit 20 to be switched from sleep mode to wakeup mode. When the data processing unit 20 has been switched to wakeup mode, the first storage status monitoring module 130 will then command the data access module 120 to retrieve the firstly-stored data package from the temporary data storage module 110 and send it to the data processing unit 20 for processing.

The data processing monitoring module 140 is coupled to the data processing unit 20 and is capable of monitoring each data processing procedure performed by the data processing unit 20 for each data package. When the data processing unit 20 completes its processing on one data package, the data processing monitoring module 140 will be informed of this condition and promptly issue a buffer-inspect message BUFFER_INSPECT to the second storage status monitoring module 150.

The second storage status monitoring module 150 is capable of being activated in response to the buffer-inspect message BUFFER_INSPECT from the data processing monitoring module 140 to inspect whether the temporary data storage module 110 is currently in empty storage status, i.e., whether it contains no data packages; and if NO (i.e., there are still one or more data packages in the temporary data storage module 110), the second storage status monitoring module 150 will promptly command he data access module 120 to retrieve the next data package in the temporary data storage module 110 and send the retrieved data package to the data processing unit 20 for processing; whereas if YES (i.e., no more data package is stored in the temporary data storage module 110), the second storage status monitoring module 150 will promptly issue a sleep enable message SLEEP_ENABLE to the data processing unit 20 to switch the data processing unit 20 back to the sleep mode.

During actual operation, whenever the data reception interface 30 receives one or more data packages from the data source 40, the data access module 120 will promptly store all the received data packages into the temporary data storage module 110.

At the time the temporary data storage module 110 is changed from empty storage status to data package storage status, i.e., when the temporary data storage module 110 receives the first data package, it will cause the first storage status monitoring module 130 to detect this condition and promptly issue a wakeup-enable message WAKEUP_ENABLE to the data processing unit 20 for the purpose of switching the data processing unit 20 from sleep mode to wakeup mode. Subsequently, when the data processing unit 20 has been switched to wakeup mode, the first storage status monitoring module 130 will command the data access module 120 to retrieve the firstly-stored data package from the temporary data storage module 110 and send it to the data processing unit 20 for processing.

While the data processing unit 20 is processing the firstly-received data package, if one or more additional data packages are received by the data reception interface 30, the data access module 120 will likewise promptly store these data packages into the temporary data storage module 110. However, at this time since the data processing unit 20 has been switched to the wakeup mode, it will not cause the first storage status monitoring module 130 to issue a wakeup-enable message WAKEUP_ENABLE to the data processing unit 20. In other words, while the data processing unit 20 is processing a data package, all subsequently received data packages during this time will be promptly stored into the temporary data storage module 110.

At the time when the data processing unit 20 completes the processing of the firstly-received data package, it will cause the data processing monitoring module 140 to promptly issue a buffer-inspect message BUFFER_INSPECT to the second storage status monitoring module 150. In response to the buffer-inspect message BUFFER_INSPECT, the second storage status monitoring module 150 is activated to inspect whether the temporary data storage module 110 is currently in empty storage status, i.e., whether the temporary data storage module 110 contains no more data packages; if NO, the second storage status monitoring module 150 will promptly command he data access module 120 to retrieve the next data package in the temporary data storage module 110 and send the retrieved data package to the data processing unit 20 for processing; whereas if YES, the second storage status monitoring module 150 will promptly issue a sleep enable message SLEEP_ENABLE to the data processing unit 20 to switch the data processing unit 20 back to sleep mode.

As the data processing unit 20 is switched to sleep mode, if the data reception interface 30 receives one or more subsequent data packages from the data source 40, it will likewise cause the batch processing wakeup/sleep mode switching control system of the invention 100 to repeat the above-described batch processing again, until the temporary data storage module 110 is empty.

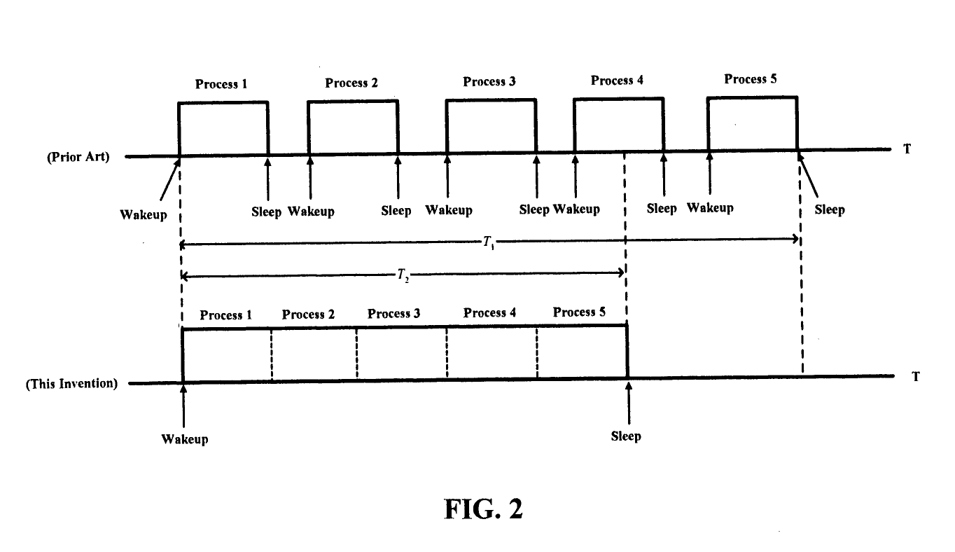

FIG. 2 is a timing diagram used to show the processing of a batch of data packages (for example 5 data packages) by the invention and by the prior art. In FIG. 2, assume Process 1, Process 2, Process 3, Process 4, and Process 5 respectively represent the durations of processing by the data processing unit 20 for these 5 data packages. By the prior art, since the data processing unit 20 is switched from sleep mode to wakeup mode and then from wakeup mode to sleep mode for each data package, an idle duration will exist between Process 1 and Process 2, between Process 2 and Process 3, between Process 3 and Process 4, and between Process 4 and Process 5 (the total time to complete the processing on these 5 data packages is represented by T₁). By contrast, since the invention switches the data processing unit 20 back to sleep mode when no more data packages are received and stored in the temporary data storage module 110, the 5 data packages can be continuously processed without having idle durations therebetween (the total time to complete the processing on these 5 data packages will be T₂, where T₂<T₁). Therefore, it is undoubtedly that the invention can help reduce the rate of switching between wakeup mode and sleep mode and thereby increase the performance of data processing of a batch of data packages. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A batch processing wakeup/sleep mode switching control method for use on an information platform that is equipped with a data reception interface and a data processing unit wherein the data reception interface is used for receiving data packages from a data source while the data processing unit is used to process each received data package, and wherein the data processing unit is switchable between a wakeup mode and a sleep mode:
the batch processing wakeup/sleep mode switching control method comprising:
storing each received data package into a temporary data storage module;
issuing a wakeup enable message to the data processing unit when the temporary data storage module is being changed from empty storage status to data package storage status, for the purpose of switching the data processing unit from sleep mode to wakeup mode;
retrieving the firstly-received data package from the temporary data storage module for processing by the data processing unit;
monitoring each data processing procedure performed by the data processing unit for each data package and generating a buffer-inspect message at the completion of the processing on each data package; and
in response to the buffer-inspect message, inspecting whether the temporary data storage module is currently in empty storage status; if NO, retrieving the next data package from the temporary data storage module for processing by the data processing unit for processing; whereas if YES, issuing a sleep enable message to the data processing unit to switch the data processing unit to sleep mode.

2. The batch processing wakeup/sleep mode switching control method of claim 1, wherein the information platform is a Web server.

3. The batch processing wakeup/sleep mode switching control method of claim 1, wherein the data reception interface is a Fibre Channel compliant data reception interface.

4. The batch processing wakeup/sleep mode switching control method of claim 1, wherein the data source is a RAID unit.

5. A batch processing wakeup/sleep mode switching control system for use with an information platform that is equipped with a data reception interface and a data processing unit wherein the data reception interface is used for receiving data packages from a data source while the data processing unit is used to process each received data package, and wherein the data processing unit is switchable between a wakeup mode and a sleep mode;
the batch processing wakeup/sleep mode switching control system comprising:
a temporary data storage module, which is used to temporarily store each received data package;
a data access module, which is capable of performing an access operation on the temporary data storage module to store each received data package into the temporary data storage module or to retrieve one data package from the temporary data storage module based on a predetermined queuing scheme;
a first storage status monitoring module, which is capable of monitoring the storage status of the temporary data storage module and capable of issuing a wakeup enable message to the data processing unit in the event that the temporary data storage module is being changed from empty storage status to data package storage status, for the purpose of switching the data processing unit from sleep mode to wakeup mode;
a data processing monitoring module, which is coupled to the data processing unit, and is capable of monitoring each data processing procedure performed by the data processing unit for each data package and capable of issuing a buffer-inspect message at the completion of the processing on each data package by the data processing unit; and
a second storage status monitoring module, which is capable of being activated in response to the buffer-inspect message to inspect whether the temporary data storage module is currently in empty storage status; if NO, the second storage status monitoring module commanding the data access module to retrieve the next data package in the temporary data storage module and send the retrieved data package to the data processing unit for processing; whereas if YES, the second storage status monitoring module issuing a sleep enable message to the data processing unit to switch the data processing unit from wakeup mode to sleep mode.

6. The batch processing wakeup/sleep mode switching control system of claim 5, wherein the information platform is a Web server.

7. The batch processing wakeup/sleep mode switching control system of claim 5, wherein the data reception interface is a Fibre Channel compliant data reception interface.

8. The batch processing wakeup/sleep mode switching control system of claim 5, wherein the data source is a RAID unit.

9. The batch processing wakeup/sleep mode switching control system of claim 5, wherein the queuing scheme on the temporary data storage module is a First-In-First-Out queuing scheme.
